(19) United States
(12) Patent Application Publication
(10) Pub. No.: US 2009/0238346 A1
(43) Pub. Date: Sep. 24, 2009

(54) Method of Copying Voice Messages in the Form of Text Messages in a Packet Communication Network

(76) Inventors: Francois Toutain, Louannec (FR); Claude Daloz, Lannion (FR); Philippe Lottin, Trebeurden (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/887,722

(22) PCT Filed: Mar. 30, 2006
(86) PCT No.: PCT/FR2006/050277

§ 371 Date: Jul. 14, 2008

(30) Foreign Application Priority Data
Mar. 31, 2005 (FR) 0503194

(51) Int. Cl. H04M 11/00

(52) U.S. Cl. 379/88.14

(57) ABSTRACT

A method of dubbing voice messages in the form of text messages, said messages being sent by a voice service element to a terminal through a packet-mode digital data transmission network in which a channel using a transmission protocol is used to transmit the voice messages. A transmission control protocol is associated with the aforementioned transmission protocol and the text messages are sent to the terminal in a channel using said transmission control protocol. The method is suitable for interpersonal communication over packet-switching communications networks.

The present invention relates to a method of dubbing voice messages in the form of text messages.

The invention finds a particularly advantageous application in the field of interpersonal audio communication over a fixed line or wireless packet-switched communications network, or more generally any network for transmitting digital data in packet mode.

In this context, there exist automatic services that supply information at the request of a user, such as interactive voice responders, which represent an extension of “Audiotel” or similar services known in switched telephone networks to digital telephony, for example to VoIP telephony.

It must nevertheless be pointed out that the invention is not limited only to exchanges between the terminal of a user and a voice server accessible directly via a clearly identified number, but extends equally to exchanges with voice service elements to which the user can be transferred via a communications system initialized by a voice server.

The object of the present invention is to be able to copy in the form of text messages voice messages sent by a voice service element, which text messages are usually text mini-messages that appear on the display of the user's terminal simultaneously with the reception of voice messages. Although the terminal can be of any type, it will be understood that the invention finds a preferred application with terminals having a hands-free function, videophone terminals, etc., and more generally terminals enabling users to listen to voice messages at the same time as reading text messages.

In the field of VoIP communication, for example, methods are known in the art that can be applied to the problem of presenting simultaneously a text message and an associated voice message.

A first solution, when setting up the call, is to negotiate an additional media channel for transmitting text data. In the context of the Real-time Transfer Protocol (RTP-RFC 3350), the stream of text data can conform to the standard payload defined in the document RTP Payload for Text Conversation (RFC 2793).

A second solution is to use the data transport possibilities of the signaling protocol to insert text data into the signaling path. One example of this technique, applicable to the Session Initiation Protocol (SIP), is described in U.S. Pat. No. 6,757,732.

Those known dubbing methods have a number of drawbacks, however.

The solution of creating an additional media stream conveying the text data requires the terminal and the voice service element to be able to manage a plurality of data sessions for the various types of transmission. Moreover, network elements such as firewalls must be configured to allow two media streams to pass instead of only one. Finally, synchronization means must be provided in order to present the text copy at the same time as the associated voice message is presented. This may require the text data to be stored in the voice service element in association with time information, such as time stamps relating to the voice samples that constitute the main message.

The second solution inherently requires the text data to transit over the signaling path, and thus to follow the route set up in the network by the call set-up messages. Note that, from the architecture point of view, this solution mixes signaling as such, which handles call management, with call content, namely the text data itself. This naturally suggests that this solution is relatively complex, since it mixes content with management actions in the same state automaton. What is more, this method is closely dependent on the signaling protocol chosen (H.323, SIP, MGCP, etc.), and consequently an implementation conforming to one type of signaling cannot be extended to another type of signaling. Finally, it should also be emphasized that, since the media data takes a more direct path, because it does not pass through the signaling equipment, problems can be expected with varying transit time-delays between the text and voice data, necessarily leading to synchronization problems with message presentation.

Thus the technical problem to be solved by the present invention is proposing a method of dubbing voice messages in the form of text messages, said messages being sent via a voice service element to a terminal over a packet-mode digital data transmission network in which a channel transporting a transmission protocol is used to send voice messages, which method would in particular avoid overly-specific use of the signaling path for transporting text messages and also avoid opening a additional media stream dedicated only to text messages.

According to the present invention, the solution to the stated technical problem is that, a transmission control protocol being associated with said transmission protocol, said text messages are sent to the terminal on a transmission control channel.

It is therefore clear that the method of the invention transfers text messages without having to open a new media stream channel, the text messages using the same path as the voice messages, which in particular avoids reconfiguring firewalls to allow this additional channel through. Moreover, the solution proposed by the invention is independent of the signaling protocol used, and it is even possible to switch from one signaling protocol to another.

According to the invention, said communication protocol is the Real-time Transport Protocol (RTP) designed to transport digital streams in the form of packets of data accompanied by their time stamps. When an RTP transmission channel is set up, a secondary an RTP transmission channel is set up, a secondary channel is also set up to transport the transmission control protocol, which is the Real-time Transport Control Protocol (RTCP). The invention uses this RTCP channel to transport text messages under practical conditions that are explained below.

In an advantageous embodiment of the invention, the terminal acts during an initialization phase, to send to said voice service element a notification message to the effect that it can receive copy text messages. This feature informs the voice service element that the terminal with which it is communicating can receive and process copy text messages. In this implementation, said voice service element sends copy text messages only if it has received a notification message from the terminal.

The invention also provides for said notification messages to be sent periodically, which ensures that the loss of a notification message in the network does not lead to aborting dubbing.

From the point of view of the voice service element, the dubbing method of the invention is activated immediately a notification message is received and subsequent notification messages are then simply ignored. The server thus remains on standby if no notification message has yet been received. Nevertheless, the server begins to send the voice message, but does not send the text message unless it has received a notification message. If the terminal does not start the process by sending a notification message, no text dubbing will occur at any time during the call.

Alternatively, the invention proposes that the periodic sending of said notification message is interrupted on reception by the terminal of a copy text message. It is therefore possible to economize on bandwidth by stopping the sending of notification messages that ceased to be useful. The periodic sending of notification messages is nevertheless recommended when transferring the call from one voice service element to another, in order to keep all the elements of the system informed.

In an implementation of the invention, said voice messages and said associated text messages are sent simultaneously. The voice and text packets sent can then be sent simultaneously unless the sending of the text messages precedes the sending of the associated voice messages, which is preferable. Under such circumstances, the text packets are sent first, immediately followed by the voice packets. The advantage of this sending mode is that it enables the terminal to review text messages before voice messages and therefore to be able to decide when to display text messages as a function of the reception of voice messages.

In this context, synchronizing voice and text messages at the receiver can be improved if, as taught by the invention, the sending of text messages precedes the sending of associated voice messages by a given time-delay period.

To make the method of the invention more reliable in the event of loss of messages in the network, there is provision for text messages to be sent periodically during the sending of an associated voice message. This ensures that at least one text message will be received by the terminal even if some of them are lost.

Finally, in one particularly advantageous implementation of the dubbing method of the invention, the terminal sends an acknowledgement message to the voice service element on reception of a copy text message. It is explained in detail below how this feature provides an entirely satisfactory solution to problems linked to message synchronization and to loss of messages.

It is as well to point out at this stage that message synchronization is ensured by the fact that, according to the invention, a voice message is sent by the voice service element on reception of an acknowledgement message.

Likewise, the possible loss of messages is taken into account if, as taught by the invention, the voice service element retransmits said text message periodically until an acknowledgement message is received.

The invention also relates to a terminal noteworthy in that it includes means for sending notification messages.

Said terminal is further noteworthy in that it includes means for sending acknowledgement messages.

The invention also relates to a voice service element noteworthy in that it includes means for sending copy text messages on reception of a notification message from the terminal.

Said voice service element is further noteworthy in that it includes means for sending voice messages on reception of an acknowledgement message from the terminal.

Said voice service element is further noteworthy in that it includes means for retransmitting copy text messages until an acknowledgement message is received from the terminal.

The following description with reference to the accompanying drawings, which are provided by way of non-limiting example, explains clearly in what the invention consists and how it can be reduced to practice.

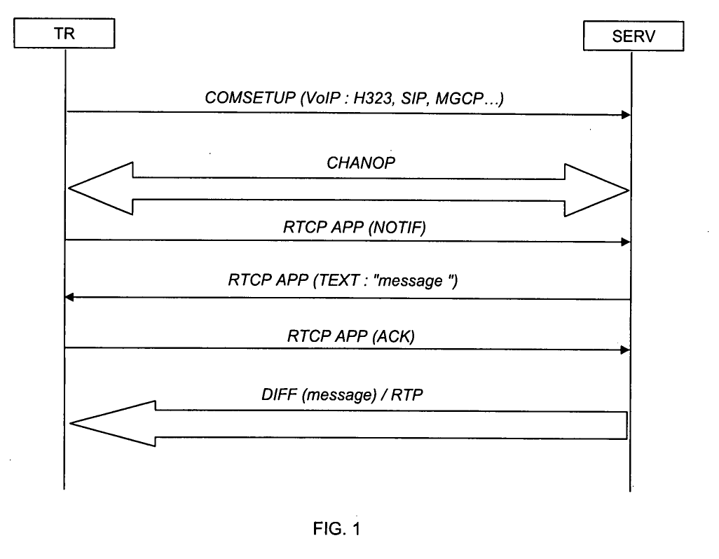

FIG. 1 is a diagram showing the exchanges between a terminal and a voice server element during execution of the dubbing method of the invention.

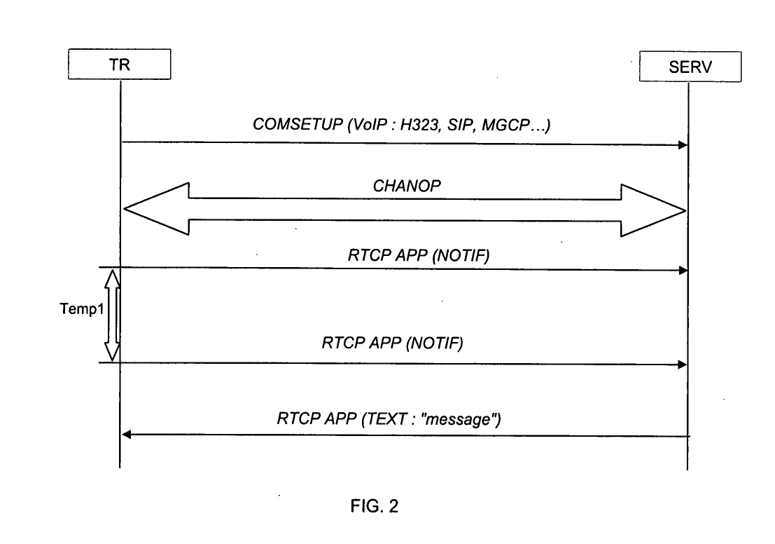

FIG. 2 represents the FIG. 1 diagram with repetition of the notification message.

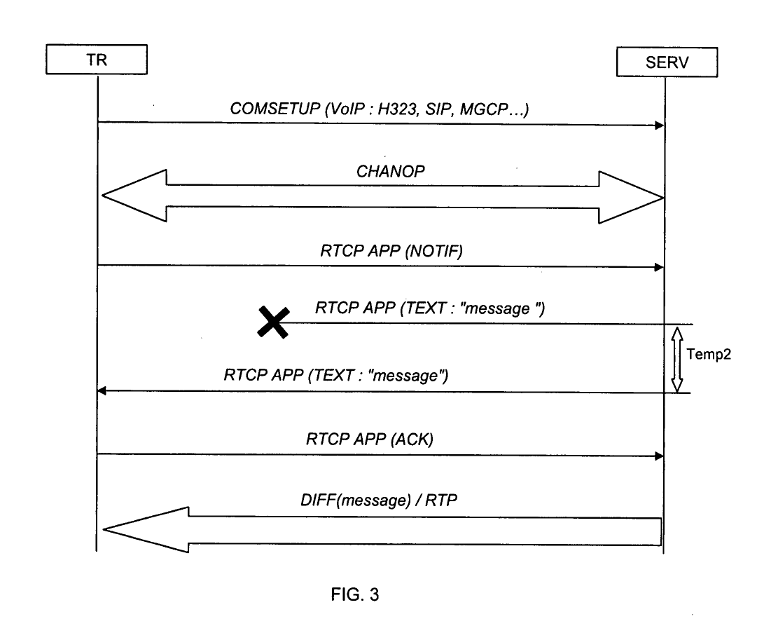

FIG. 3 represents the FIG. 1 diagram with loss of the text message.

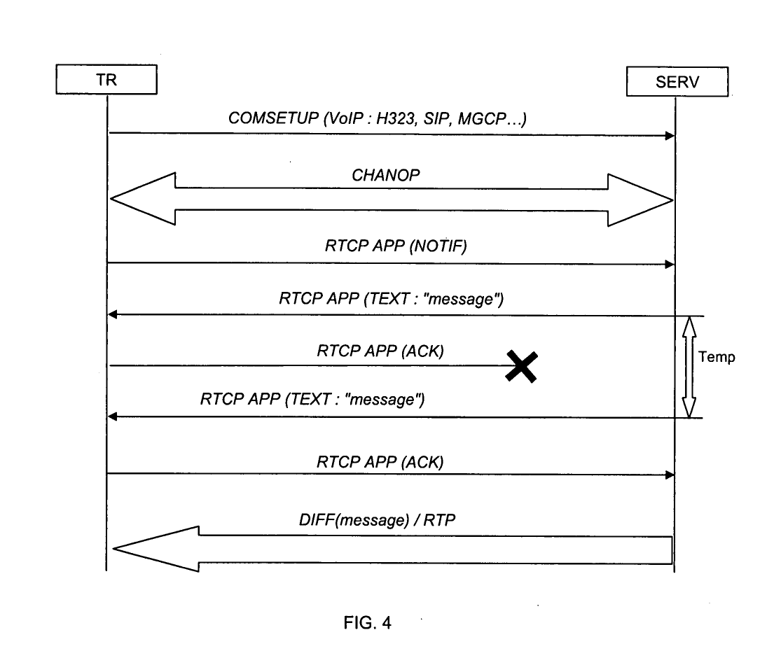

FIG. 4 represents the FIG. 1 diagram with loss of the acknowledgement message.

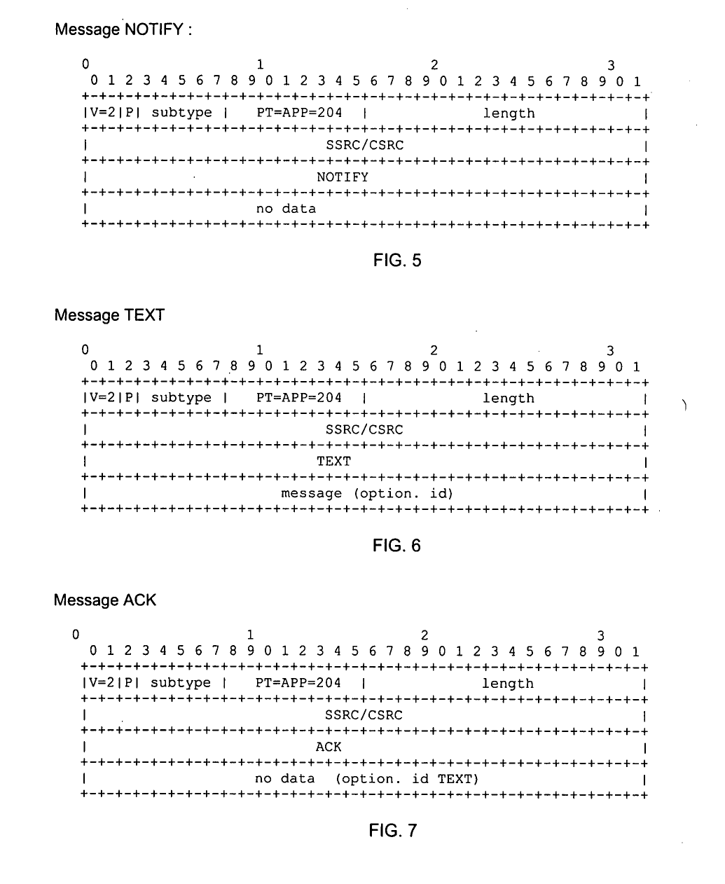

FIG. 5 is an example of coding the message NOTIF in an RTCP packet APP.

FIG. 6 is an example of coding the message TEXT in an RTCP packet APP.

FIG. 7 is an example of coding the message ACK in an RTCP packet APP.

FIGS. 1 to 4 relate to a method of dubbing in the form of text messages voice messages sent by a voice service element SERV to a terminal TR. The text messages are designated TEXT in the remainder of the description.

Voice messages are transported over a channel of a transmission protocol in a packet-switched network. That protocol can be the Real-time Transport Protocol (RTP) mentioned above, for example.

The messages TEXT, and other messages associated with the dubbing process, such as notification messages NOTIF and acknowledgement messages ACK, are transported on a transmission control channel, called RTCP in the RTP protocol.

The messages exchanged on this control channel are as follows (see RFC 3550):
message SDES (Source DEScription): contains information that identifies and characterizes a media stream data source;
message SR (Sender Report): contains statistical data established by a source or a sender and processed by the receiver or receivers to adjust the quality of service of the stream;
message RR (Receiver Report): contains statistical data established by each receiver and processed by the corresponding sender to adjust its transmission;
message APP (APPlication): a complementary message that can be used by the communicating application to convey application level control information;
message BYE: a message sent by a source leaving the communication session.

The dubbing method of the invention uses the messages APP to transmit messages NOTIF, TEXT and ACK.

FIGS. 5 to 7 show examples of coding these messages in APP packets.

The FIG. 1 diagram shows the steps of the method of the invention during standard operation.

Preliminary operations COMSETUP and CHANOP respectively leading to call set-up and media channel opening are not described in detail here. These operations are part of the VoIP signaling protocols (H.323, SIP, MGCP, etc.) and are known in themselves and independent of the invention as such.

When the call and the media channels have been set up, the terminal TR sends the voice service element SERV an RTCP message APP containing a message NOTIF to indicate that it can display a copy message TEXT.

Then, before the voice service element SERV sends a voice message, it sends the terminal TR an RTCP message APP TEXT containing the text of the copy message to be displayed.

On receiving this message TEXT, the terminal TR responds by sending the voice service element SERV an RTCP message APP containing an acknowledgement message ACK indicating to said element SERV that the message TEXT has been received correctly.

After it has received this message ACK, the voice service element SERV can send the voice message, which is then synchronized by the terminal TR with the copy text message according to the display strategy adopted in the terminal TR. The terminal TR can decide to display the text message as soon as it is received, without waiting to receive the associated voice message, or to retain the text message until the voice message is received, in order to display the text message simultaneously with reception of the voice message.

To improve management of message synchronization, it is possible to institute a reference mechanism. For each text message to be displayed by the terminal TR, the voice service element SERV defines an identifier which is modified for the next text message and which is repeated by the terminal TR in the corresponding message ACK. This identifier can be incremented by the server when each message TEXT is sent or each time a different text message to be displayed is sent. Under such circumstances, if a message TEXT is lost, the retransmitted message TEXT still has the same identifier.

FIG. 2 shows a mechanism for periodic retransmission of the message NOTIF. After sending a first message NOTIF, the terminal TR sets a time-out Temp1. When the time-out expires, the terminal TR sends the message NOTIF again and starts a new time-out Temp1, etc. Thus, even if a message NOTIF is lost, the voice service element SERV will nevertheless be informed that the terminal TR can process the copy text message. This retransmission mechanism is particularly useful when using a relatively unreliable transport protocol. As already explained above, the repetition of the message NOTIF can be stopped by reception of a first message TEXT from the voice service element SERV, which has the advantage of economizing on bandwidth but the drawback of breaking the transmission of the information contained in the message NOTIF across the chain of possible call transfers.

FIG. 3 shows the mechanism set up to avoid the loss of the copy text message TEXT. When the voice service element SERV sends a first message TEXT, it initializes a time-out Temp2. If it has not received any acknowledgement message ACK corresponding to the message TEXT when this time-out expires, it retransmits the same message TEXT and restarts the time-out Temp2. If, subsequently, it receives a message ACK, it stops this time-out Temp2 and starts sending the voice message associated with the message TEXT.

Alternatively, the voice service element SERV can send the message TEXT and simultaneously start sending the media stream. Under such circumstances, synchronization between the media stream and its text copy is less refined, but the process is simpler because it no longer requires the use of an acknowledgement message ACK.

This variant can be improved if the voice service element SERV sends the message TEXT and starts to send the voice message after a time-delay, without waiting to receive an acknowledgement. Under such circumstances, synchronization is more refined but the process is nevertheless simpler.

FIG. 4 shows the mechanism set up to avoid loss of the acknowledgement message ACK. As with the loss of a message TEXT, if the message ACK sent back by the terminal TR does not reach the voice service element SERV, the voice service element retransmits the RTCP message APP TEXT after a time-out Temp that can have the same duration as the time-out Temp2. The mechanism continues to run until the voice service element SERV receives a message ACK, whereupon said voice service element SERV sends the voice message.

In this configuration, if the message ACK is lost, the terminal TR may present the text message before the message ACK reaches it. The order of magnitude of the delays is such that users will probably not perceive any annoying time difference. In fact, the dubbing service does not require highly-refined synchronization of the information, but only a behavior analogous to that of audiovisual subtitling, for example.

Generally speaking, it should be noted that optimization of the retransmission intervals can be based on the fact that the entities at ends of an RTP exchange can calculate an estimate of the round trip time in the network by means of the RTCP messages SR and RR. That estimate can be used to determine the retransmission period for the messages TEXT and ACK.

1. A method of dubbing voice messages in the form of text messages, said messages being sent by a voice service element to a terminal over a packet-mode digital data transmission network in which a channel transporting a transmission protocol is used for sending voice messages, wherein the method comprises the steps of:
associating a transmission control protocol with said transmission protocol; and
sending said text messages (TEXT) to the terminal on a channel transporting said transmission control protocol.

2. The method according to claim 1, wherein, during an initialization phase, the terminal sends said voice service element a message (NOTIF) to notify that it can receive copy text messages (TEXT).

3. The method according to claim 2, wherein said notification message (NOTIF) is sent periodically.

4. The method according to claim 3, wherein the periodic sending of said notification message (NOTIF) is interrupted on reception by the terminal of a copy text message (TEXT).

5. The method according to claim 1, wherein said voice messages and said associated text messages (TEXT) are sent simultaneously.

6. The method according to claim 1, wherein sending text messages (TEXT) precedes sending the associated voice messages.

7. The method according to claim 6, wherein sending of text messages (TEXT) precedes sending the associated voice messages by a given time-delay.

8. The method according to claim 5, wherein text messages (TEXT) are sent periodically during the sending of an associated voice message.

9. The method according to claim 1, wherein the terminal sends the voice service element an acknowledgement message (ACK) on reception of a copy text message (TEXT).

10. The method according to claim 9, wherein the voice service element sends a voice message on reception of an acknowledgement message (ACK).

11. The method according to claim 9, wherein the voice service element retransmits said text message (TEXT) periodically (T2) until an acknowledgement message (ACK) is received.

12. The method according to claim 1, wherein said communication protocol is the Real-time Transport Protocol (RTP).

13. The method according to claim 12, wherein said notification messages, said copy text messages and said acknowledgement messages are sent in messages APP of the Real-time Transmission Control Protocol (RTCP) associated with said Real-time Transport Protocol (RTP).

14. The terminal comprising means for sending notification messages when it makes use of the method according to claim 2.

15. A terminal according to claim 14, comprising means for sending the voice service element an acknowledgement message on reception of a copy text message.

16. A voice service element adapted to send voice messages copied by text messages to a terminal over a packet-mode digital data transmission network in which a channel transporting a transmission protocol is used for sending voice messages, a transmission control protocol being associated with said transmission protocol, wherein the voice service element comprises means for sending said text messages (TEXT) to said terminal on a channel transporting said transmission control protocol.

17. A voice service element adapted to send voice messages copied by text messages to a terminal over a packet-mode digital data transmission network in which a channel transporting a transmission protocol is used for sending voice messages, a transmission control protocol being associated with said transmission protocol, wherein the voice service element comprises:
means for sending said text messages (TEXT) to said terminal on a channel transporting said transmission control protocol; and
means for sending said text messages (TEXT) to said terminal on a channel transporting said transmission control protocol means for sending copy text messages on reception of a notification message from the terminal when it makes use of the method according to claim 2.

18. A voice service element adapted to send voice messages copied by text messages to a terminal over a packet-mode digital data transmission network in which a channel transporting a transmission protocol is used for sending voice messages, a transmission control protocol being associated with said transmission protocol, wherein the voice service element comprises:
means for sending said text messages (TEXT) to said terminal on a channel transporting said transmission control protocol; and
means for sending voice messages on reception of an acknowledgement message from the terminal when it makes use of the method according to claim 10.

19. A voice service element adapted to send voice messages copied by text messages to a terminal over a packet-mode digital data transmission network in which a channel transporting a transmission protocol is used for sending voice messages, a transmission control protocol being associated with said transmission protocol, wherein the voice service element comprises:
means for sending said text messages (TEXT) to said terminal on a channel transporting said transmission control protocol;
means for sending voice messages on reception of an acknowledgement message from the terminal when it makes use of the method according to claim 10; and
means for retransmitting copy text messages until an acknowledgement message is received from the terminal when the voice service element retransmits said text message (TEXT) periodically (T2) until an acknowledgement message (ACK) is received.
